(19) United States
(12) Patent Application Publication
(10) Pub. No.: US 2012/0243273 A1
(43) Pub. Date: Sep. 27, 2012

(54) MULTI-LEVEL, MULTI-VOLTAGE MATRIX CONVERTER CIRCUIT AND METHOD FOR IMPLEMENTING SUCH A CIRCUIT

(75) Inventor: Ignace Rasoanarivo, Villers Les Nancy (FR)

(73) Assignee: UNIVERSITE DE LORRAINE, Nancy Cedex (FR)

(21) Appl. No.: 13/509,001

(22) PCT Filed: Nov. 10, 2010
(86) PCT No.: PCT/FR2010/052408

§ 371 Date: Jun. 6, 2012

(30) Foreign Application Priority Data
Nov. 10, 2009 (FR) 09/57944

(51) Int. Cl. H02M 1/12; H01R 43/20; H02M 7/537

(52) U.S. Cl. 363/41; 363/131; 29/876

(57) ABSTRACT

A matrix converter circuit with n symmetrical levels per phase including n conversion arms respectively supplied with n intermediate symmetrical voltage levels and connected at the output thereof to a common point generating an output current, characterized in that it includes:
two external arms supplied respectively with the highest level of positive voltage and with the lowest level of negative voltage, these two external arms each including a single IGBT transistor, and
two IGBT transistors connected in series by their emitter on each of the n−2 internal arms.

The present invention relates to a matrix converter circuit with n levels per phase comprising n conversion arms respectively supplied with n intermediate voltage levels and connected at the output thereof to a common point generating an output current. Such a circuit is also called a multi-level voltage inverter.

Generally, in power electronics, multi-level inverter technology proposes numerous topologies including mainly the NPC or “Neutral Point Clamped” type and MPC or “Multi Point Clamped” type. Their main characteristics are:
the existence of clamp diodes in their architecture; and
with respect to the output voltage waveform, an odd number of levels for the NPC and even for the MPC.

The multi-level inverters are initially designed for high voltage. Therefore, by means of topological modifications, it is generally sought to increase power by generating higher voltages, and it is also sought to obtain output signals having a reduced harmonic content.

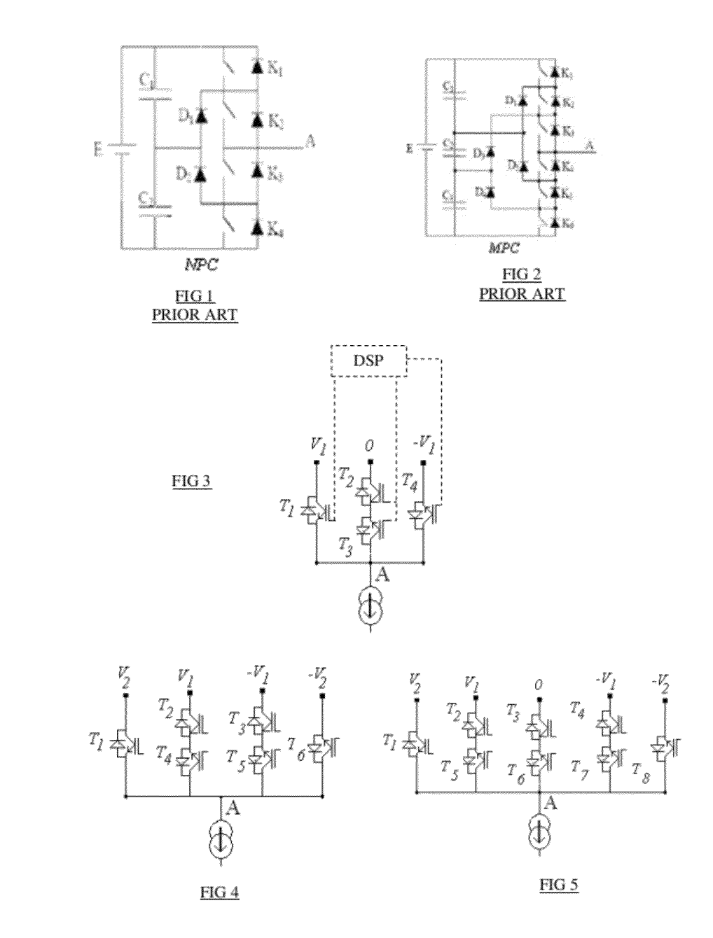

The standard NPC and MPC structures are diagrammatically represented in FIGS. 1 and 2 respectively. FIG. 1 shows a three-level single-phase NPC structure having a DC voltage source E supplying two capacitors C1 and C2 so as to obtain three different DC voltage levels: E/2, 0 and −E/2. The voltage across the terminals of each capacitor C1 and C2 being equal in absolute value to E/2. The diodes D1 and D2, so-called “clamp” diodes, make it possible to limit the relative voltage across each of the capacitors. In principle, for an NPC (“Neutral Point Clamped Multilevel Inverter”) type N-level multilevel inverter, the equations giving the number of the different components involved in the topology are:
number of capacitors BC=N−1;
number of transistors (switches) NT=2(N−1), and
number of clamp diodes per phase NDC=2(N−2).

In FIG. 1, the output switches are transistors each associated with a diode K1, K2, K3 and K4.

FIG. 2 shows a five-level single-phase structure. Similarly, the capacitors C1, C2 and C3 make it possible to obtain four different voltages from a DC voltage source E. At the output, there are six switches (a transistor Tᵢ associated with a diode Kᵢ). The output A is arranged between the transistors T3 and T4. The highest voltage (at the positive terminal of the capacitor C1) supplies the transistor T1, whereas the most negative voltage supplies the transistor T6. The DC voltage between the capacitors C1 and C2 supplies the point of intersection between the transistors T1 and T2 via the clamp diode D1 on the one hand, and supplies the point of intersection between the transistors T4 and T5 via the clamp diode D2 on the other hand. Similarly, the DC voltage between the capacitors C2 and C3 supplies the point of intersection between the transistors T2 and T3 via the clamp diode D3 on the one hand, and supplies the point of intersection between the transistors T5 and T6 via the clamp diode D4 on the other hand.

Such types of multi-level inverters are used mainly for high voltages. As regards average- and low-voltage systems, two-level inverters are generally used. Such systems are for example on-board systems. In wind turbines in particular, for double-fed asynchronous machines, two-level inverters are used. Their chopping frequency is relatively high and it is found that the power factor is generally degraded.

The document U.S. Pat. No. 6,930,899 is known, which describes topologies without clamp diodes with arms having a series of two IGBT transistors connected by their collector and not by their emitter. The device described in this document makes it possible to reduce the number of components so as to improve the quality of the output signal. However, this device also comprises numerous components which is detrimental with regard to consumption and to the electromagnetic compatibility required of any radiating device, and the design of such a device still remains expensive.

A purpose of the present invention is therefore a multi-level matrix inverter for which the consumption is reduced compared with devices of the prior art.

Another purpose of the invention is the development of novel structures of N-level inverters designed for low voltage.

A purpose of the present invention is also a rapid and inexpensive design of a novel structure of an N-level inverter.

At least one of the abovementioned objectives is achieved with a matrix converter circuit with n levels per phase comprising n conversion arms supplied respectively with n intermediate voltage levels and connected at the output thereof to a common point generating an output current. According to the invention, this matrix converter circuit comprises:
two external arms supplied with the highest level of positive voltage and with the lowest level of negative voltage respectively, these two external arms each comprising a single IGBT transistor, and
two IGBT transistors connected in series by their emitter on each of the n−2 internal arms.

This matrix converter circuit according to the invention results in a simplified topology where the conduction of current is ensured by a single transistor on an external arm and by a four-quadrant transistor on an internal arm. The conduction losses of the switches are lower than those of the standard NPC and MPC converters. The number of power switches used is reduced compared with conventional NPC or MPC type circuits. The inverter according to the invention comprises no clamp diodes; by clamp diode is meant a diode which connects a fixed-potential point on the side of the capacitor banks to another point on the inverter arm.

The present invention proposes a novel structure of N-level inverters designed in particular for low voltage. As a non-limitative example, this inverter according to the invention will preferably be used when N is less than or equal to five. It is possible to work with all the intermediate levels of the power supply: from two to N, and therefore possible to adjust the RMS value of the output voltage.

With respect to the document U.S. Pat. No. 6,930,899, the inverter according to the invention comprises only a single IGBT transistor on the external arms.

According to an advantageous characteristic of the invention, the converter circuit according to the invention comprises a control unit supplied with a measurement of the output current and configured so as to control the IGBT transistors by modulated hysteresis. In other words, a modulated hysteresis-type current feedback loop is added. Therefore, the current harmonic distortion level (THD) tends towards zero and the power factor is significantly improved thereby. This quality is particularly useful for all-electric on-board systems with a time-limited power supply.

Advantageously, the converter circuit according to the invention can comprise a feedback loop including a Hall effect sensor for measuring the output current.

Advantageously, the modulated hysteresis control unit comprises:
an adder for adding a triangular carrier with a current set point resulting from comparison between said current measurement and a current reference,
a hysteresis comparator supplied by the adder, and
a signal-processing circuit supplied by the hysteresis comparator and generating control signals for the IGBT transistors.

In other words, this is a pulse width modulation (PWM) control obtained with a sinusoidal wave and a single carrier wave. Such a control can advantageously be achieved by means of a DSP “digital signal processor” type digital processing card.

Preferably, the modulated hysteresis current control unit is completely analog, therefore simple and robust. This principle makes it possible to greatly improve the power factor of the converter circuit, therefore allowing sustainable and optimum use of the electrical energy involved.

According to an advantageous characteristic of the invention, the control unit is configured so as to produce a chopping frequency less than five kHz. With a low chopping frequency, the switching losses are considerably reduced and the converter efficiency remains high with an extended lifetime of the IGBT transistors.

With the use of the IGBT transistors, the converter circuit according to the invention operates with hard switching, however with enhanced reliability and viability. By way of illustration and non-limitatively, the control unit can be configured so as to produce a chopping frequency equal to two kHz.

According to an advantageous embodiment of the invention, the converter circuit according to the invention comprises cabling constituted by flat “bus bar” type conductors comprising a plurality of metal plates for supplying the conversion arms, each conductor being able to be constituted by several laminated metal plates.

According to an advantageous characteristic of the invention, at least one of the two external arms also comprises a diode in series with the single IGBT transistor, the anode of the diode being connected to the emitter of the IGBT transistor. It is also possible to provide an embodiment in which at least one of the two external arms also comprises two diodes in parallel but in opposite directions, the assembly constituted by these diodes being placed in series with the single IGBT transistor. With such embodiments, the voltage drop at the terminals of the external arms is limited, which is beneficial for high voltage working.

Such an embodiment provides very good behaviour in terms of electromagnetic compatibility thanks to very low voltage (THDv) and current (THDi) distortion level values. This cabling is in particular used for interconnections between other power circuits and the present converter circuit.

The characteristics thus defined contribute to enhancing the viability of the converter circuit according to the present invention with a not insignificant saving in consumption and better quality of the electric energy.

According to another aspect of the invention, a method for designing a matrix converter circuit as defined above is proposed. In the method according to the invention, said converter circuit is designed by assembling several identical modular components.

Advantageously, the modular component comprises two parallel arms each intended to receive an intermediate-level input voltage, these arms being connected at the output at a point constituting said common point generating an output current. Within this modular component:
each arm comprises an IGBT transistor connected in series with a mechanical switch;
on the arm to be supplied with the highest voltage level, the collector of the IGBT transistor is arranged on the side of the input capable of receiving this highest voltage level; the mechanical switch being arranged between this IGBT transistor and the common point;
on the arm to be supplied with the least high voltage level, the emitter of the IGBT transistor is arranged on the side of the input capable of receiving this least high voltage level; the mechanical switch being arranged between this IGBT transistor and this input capable of receiving this least high voltage level.

With such a design method and modular components thus defined, it becomes easy to rapidly design a converter circuit according to the invention by interlocking, thus considerably reducing the cost and time needed to design a converter circuit.

More precisely, it is provided that the design is achieved by lateral interlocking of the identical modular components so as to constitute the desired converter circuit; each IGBT transistor being associated with a mechanical stop intended by design to disconnect a mechanical switch.

According to the invention, each modular component comprises a capacitor bank arranged at the input between the two arms.

Other advantages and characteristics of the invention will become apparent on examining the detailed description of an embodiment which is in no way limitative, and the attached drawings in which:

FIG. 1 is a diagrammatic view of an NPC structure according to the prior art;

FIG. 2 is a diagrammatic view of an MPC structure according to the prior art;

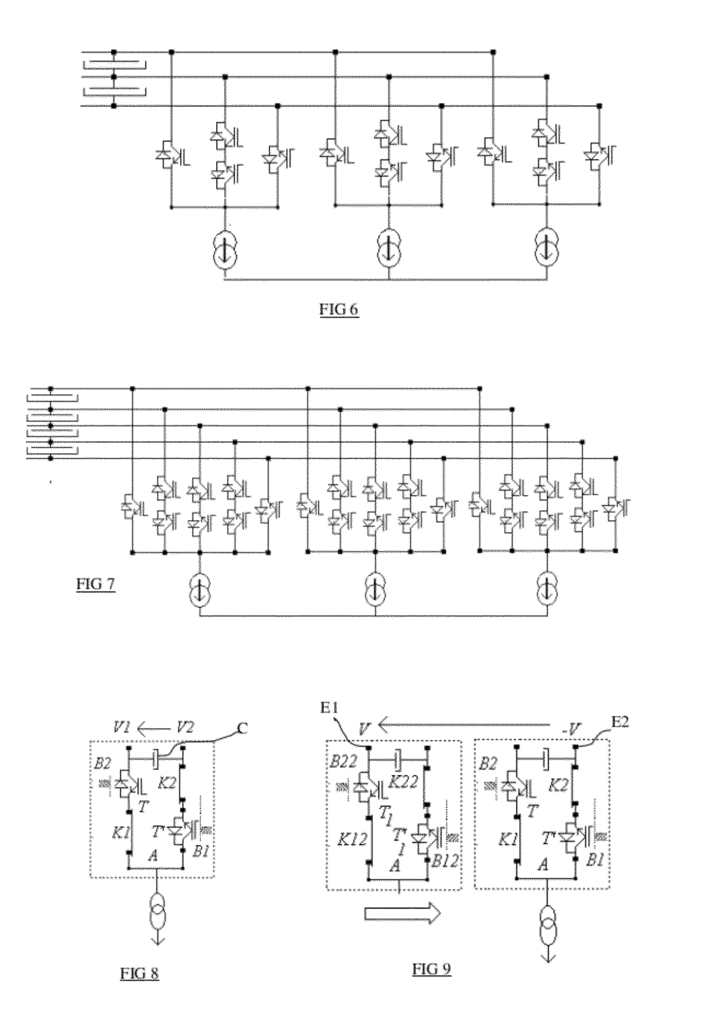

FIG. 3 is a diagrammatic view of a single-phase three-level matrix inverter according to the invention;

FIG. 4 is a diagrammatic view of a single-phase four-level matrix inverter according to the invention;

FIG. 5 is a diagrammatic view of a single-phase five-level matrix inverter according to the invention;

FIG. 6 is a diagrammatic view of a three-phase three-level matrix inverter according to the invention;

FIG. 7 is a diagrammatic view of a three-phase five-level matrix inverter according to the invention;

FIG. 8 is a diagrammatic view of a modular component for the interlocking design of a matrix inverter according to the invention;

FIG. 9 is a diagrammatic view of a single-phase three-level matrix inverter designed on the basis of two modular components according to the invention;

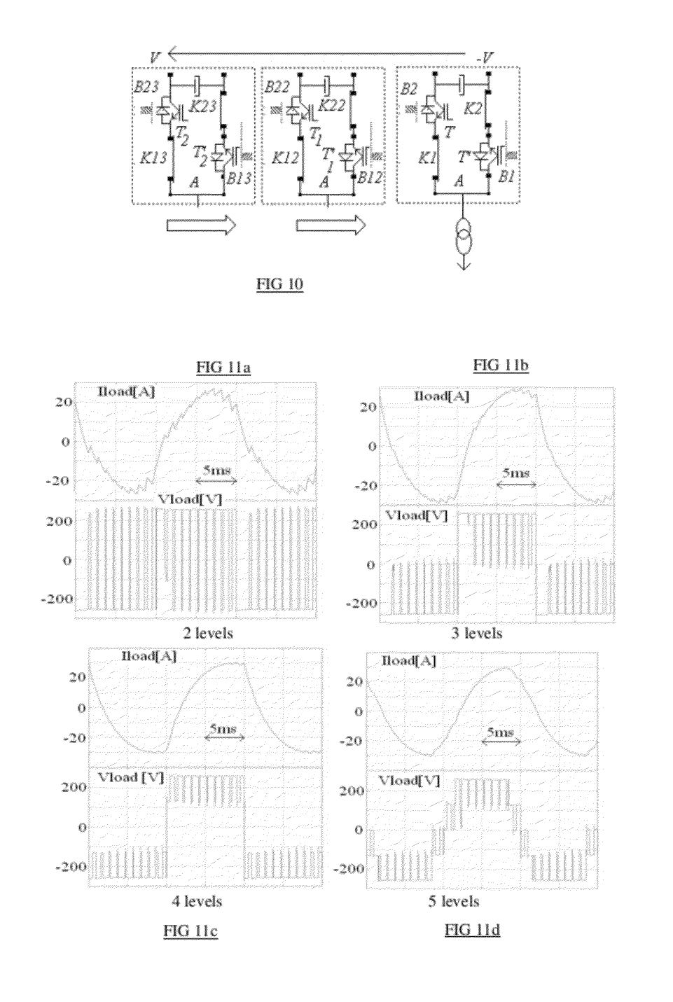

FIG. 10 is a diagrammatic view of a single-phase four-level matrix inverter designed on the basis three modular components according to the invention;

FIGS. 11a, 11b, 11c and 11d illustrate operating curves for 2, 3, 4 and 5-level inverters respectively in degraded mode according to the invention;

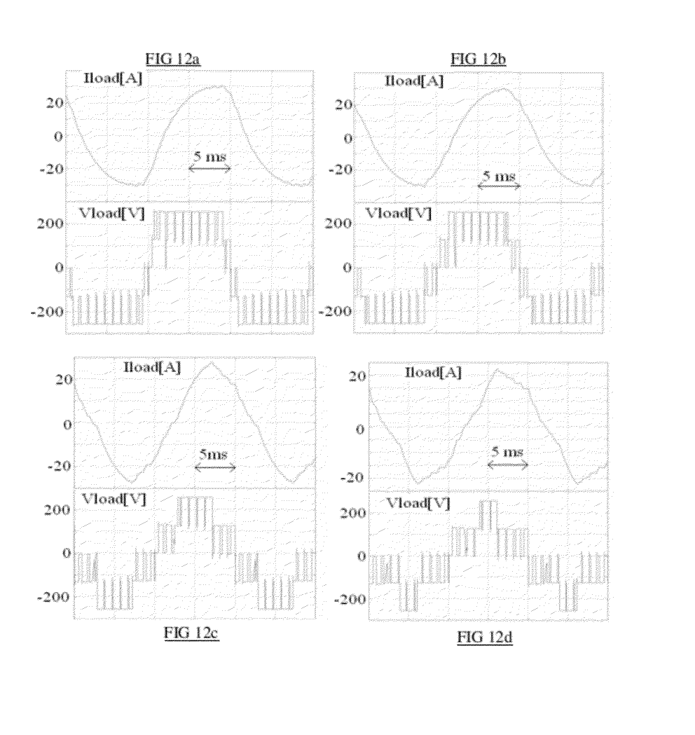

FIGS. 12a, 12b, 12c and 12d illustrate operating curves for a stage-switching 5-level inverter according to the invention;

FIGS. 13a-13f illustrate operating curves for a three-phase 3-level inverter according to the invention;

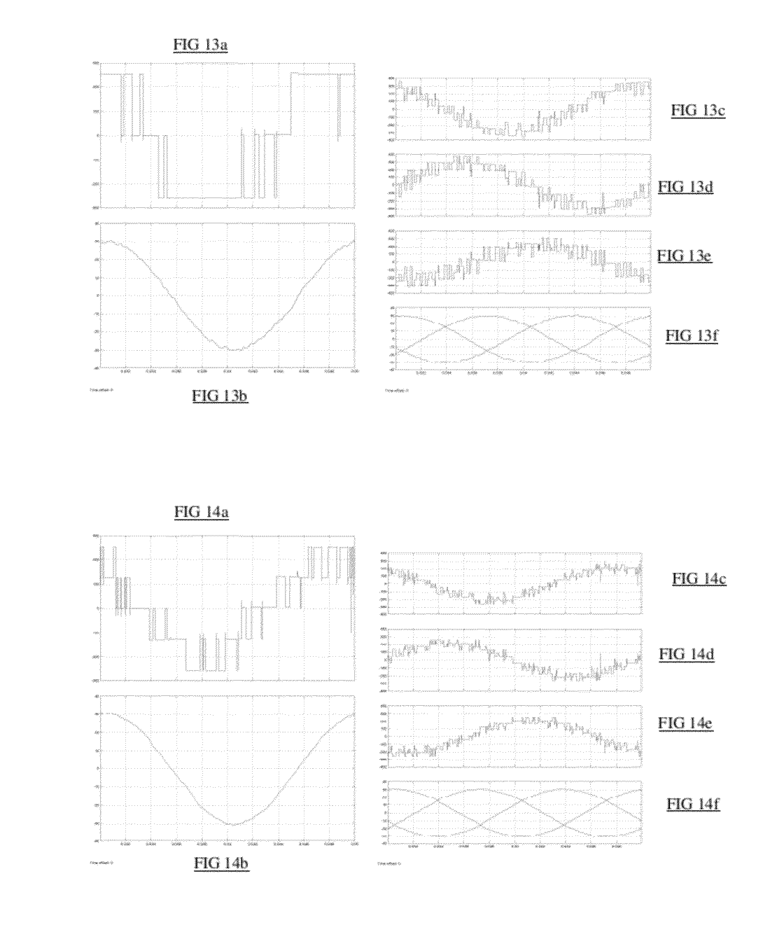

FIGS. 14a-14f illustrate operating curves for a three-phase 5-level inverter according to the invention;

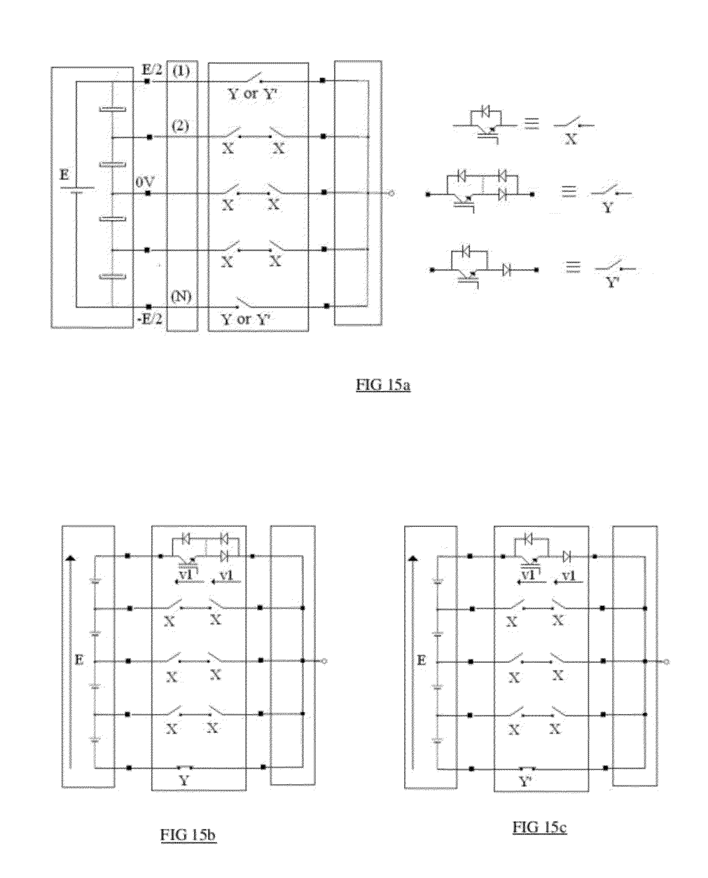

FIGS. 15a, 15b and 15c are diagrammatic views of a single-phase “N”-level matrix inverter comprising voltage drop limitation switches according to the invention; and

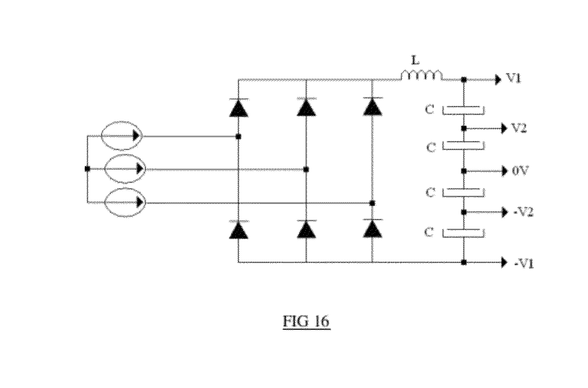

FIG. 16 is a diagrammatic view of a DC voltage source with capacitor banks.

FIG. 3 shows an example of a three-level matrix inverter or converter according to the present invention. The DC voltage source and the capacitors are not shown. This three-level inverter comprises three arms supplied with three DC voltage levels V1, 0 and −V1 respectively. The two external arms are the arms supplied with V1 and −V1 respectively. The external arm supplied with V1 comprises a switch T1 constituted by an IGBT transistor in parallel with a diode. The emitter of the IGBT transistor is connected to the anode of the diode, the collector of the IGBT transistor being connected to the cathode of the diode. Hereafter, such an assembly constituted by an IGBT transistor and a diode arranged in parallel as indicated above, is called an “IGBT switch”. Thus, the second external arm supplied with −V1 comprises an IGBT switch T4. The two IGBT switches T1 and T4 are connected, by their emitter, at a common point A constituting the output of the three-level inverter. The output signal is a current signal modulated as a function of the conduction and switching of the different switches of the inverter. The internal arm supplied with zero voltage comprises two IGBT switches T2 and T3 arranged in series and connected to each other by their emitter. The 0 volt voltage thus supplies the collector of the IGBT switch T2, which in turn supplies the emitter of the IGBT switch T3, the latter having its collector connected to the common point A. With respect to the device NPC of the prior art, clamp diodes are not used here, but by contrast a single IGBT transistor in the external arms. The switches T2 and T3 of the internal arm constitute a four quadrant switch thus comprising two IGBT transistors connected in series by their emitter.

FIG. 3 also shows a DSP module which is an electronic card equipped with standard microprocessors and/or DSP (“Digital Signal Processing”) type microprocessors and designed so as to generate control signals of the IGBT transistors. Preferably a pulse width modulation (PWM) control is carried out based on a sinusoidal wave and a single carrier wave with a relatively low chopping frequency compared with the devices of the prior art. This control is preferably of completely analog design.

With such an inverter having a minimum number of power switches and controlled according to a strategy which can be carried out in completely analog mode, a reasonable manufacturing cost and a more robust and viable inverter or converter are obtained.

As a variant, it is possible to apply a “modulated hysteresis” type control strategy so as to improve the output current waveform by reducing the harmonics. The “modulated hysteresis” method combines the advantages of a PWM control and a simple hysteresis control. This method makes it possible to impose a chopping frequency of the IGBT transistors of the inverter during hysteresis control of the output current. More precisely, the output current is measured and then compared to a reference value. The result of this comparison is added to a triangular carrier. The assembly then supplies a hysteresis comparator which then generates a control signal which is then formatted as a logic control signal. An additional logic control signal is also generated. The two logic control signals act on the two IGBT transistors of an internal arm of the inverter respectively.

Moreover, the switching losses of a transistor being proportional to the control pulse frequency, control is carried out at low frequency, of the order of 1 to 2 kHz instead of the usual 5 to 10 kHz. There is less heating of the transistors, hence an extension of their lifetime and a advantageous overall efficiency of the inverter.

Earthed laminated cabling is also provided so as to reduce the common-mode currents. As a non-limitative example, it is possible to use copper sheets (thickness 0.5 mm) and insulating sheets (thickness 0.035 mm) in order to produce flat conductors. These conductors are used on the arms of the inverter.

These conductors can for example be very thin and be constituted by three large parallel plates in a plane containing the inverter. The three plates are separated by insulating materials which are also thin. Advantageously, the three arms correspond to the two external arms and the internal arm respectively. The ratio between on the one hand the thickness of the insulating materials and that of the plates, and on the other hand the large dimensions of the plates can be 1/500. Such a laminated conductor is sometimes referred to as a “bus bar”.

FIG. 4 shows a four-level inverter according to the invention. The input DC voltages are four voltages V2, V1, −V1 and −V2 supplying respectively:
an external arm bearing an IGBT switch T1,
an internal arm bearing two IGBT switches T2, T4, in series and connected by their emitter,
a second internal arm bearing two IGBT switches T3, T5, in series and connected by their emitter, and
a second external arm bearing an IGBT switch T6.

FIG. 5 shows a five-level inverter according to the invention. The input DC voltages are five voltages V2, V1, 0, −V1 and −V2 supplying respectively:
an external arm bearing an IGBT switch T1,
an internal arm bearing two IGBT switches T2, T5, in series and connected by their emitter,
a second internal arm bearing two IGBT switches T3, T6, in series and connected by their emitter,
a third internal arm bearing two IGBT switches T4, T7, in series and connected by their emitter, and
a second external arm bearing an IGBT switch T8.

The external arms comprise only a single IGBT transistor and the internal arms two IGBT transistors in series connected by their emitter.

Thus, the topology according to the invention is adaptable to any number of levels: even and odd. It therefore behaves simultaneously as an NPC inverter (odd number of levels) and as MPC and “H-Bridge” inverters (even number of levels, where the potential equal to 0 is not accessible). However, it is distinguished from the NPC and MPC inverters in particular by the absence of the clamp diodes, and from the H-Bridge inverter by a single capacitor-bank bus.

The 3 and 5-level three-phase versions are shown in FIGS. 6 and 7.

According to an advantageous embodiment of the invention, the inverter can be obtained from the modular component illustrated in FIG. 8, with V₁>V₂. This is a 2-level inverter arm. This module comprises at least one capacitor C, two IGBT switches T (the collector of which is connected to the positive potential of the bus bar providing the voltage V₁) and r (the emitter of which is connected to the negative potential of the bus bar providing the voltage V₂), two mechanical switches K₁ and K₂, two mechanical stops B₁ and B₂. The load is connected directly to point A.

FIG. 9 shows an example of a modular design of a 3-level inverter according to the invention. By engaging another module, for example on the left side, the stop B₁₂ will open the mechanical switch K₁ and T′₁ will be placed in the position of K₁. This same is true for B₂ on K₂₂: T will be placed in the position of K₂₂. Thus a 3-level inverter according to the invention is obtained: a bus bar (not shown) providing the DC voltage will be connected on the ends E1 and E2, the output being point A for the supply of a load.

FIG. 10 shows an example of a modular design of a 4-level inverter.

Thus, the number of levels K can be directly related to the number of modules. For N modules there will be K=N−1 levels.

Because of its property of modularity, the converter according to the invention can operate in degraded mode. The operating curves for a number of levels ranging from 2 to 5, for a 5-level single-phase inverter, obtained by open-loop simulation, are given in FIGS. 11a, 11b, 11c and 11d. The number of voltage choppings is clearly visible as the frequency used is 1000 Hz.

The possibility of operating in degraded mode emphasizes the enhanced viability and especially the reliability of the inverter as, in the event of the failure of any arm, the device can still continue to work with a smaller number of levels. This degraded mode consists of modifying the control of the switches so as to maintain the power transmitted to the load in normal mode or in the event of a failure. In the latter case, the device can continue to work symmetrically with a smaller number of levels.

Then, for a fixed number of levels, the curves in FIGS. 12a, 12b, 12c and 12d show the open-loop operation of a 5-level inverter by so-called stage-switching regulation. This action makes it possible to vary the duration of a plateau value of the output voltage: it is thus possible to regulate the total RMS value and the fundamental value of the output voltage of the inverter.

The curves thus obtained make it possible to emphasize that the RMS values of the voltages and output currents can be regulated. The stage-switching thus makes it possible to regulate the output power of the inverter.

The converter is highly adaptable to the usual control techniques. In order to obtain sinusoidal waveforms of the currents delivered, the principle of modulated hysteresis control is applied. In this case, FIGS. 13a-13f, 14a-14f illustrate waveforms in the case of a modulated hysteresis control for 3- and 5-level three-phase inverters. The currents delivered are perfectly sinusoidal despite a relatively low chopping frequency: 1000 Hz. More precisely, FIGS. 13a-13f illustrate waveforms of the line currents, of the voltage between point A and the mid-point of the bus bar VA0, of the voltages between phase and neutral for a 3-level three-phase inverter.

FIGS. 14a-14f illustrate waveforms of the line currents, of the voltage between point A and mid-point of the bus bar VA0, of the voltages between phase and neutral for a 5-level three-phase inverter.

In addition to the above in particular, a novel topology for high voltage is provided, making it possible to limit the forward blocking voltage of the switches, i.e. of the IGBT transistors, of the external arms. FIG. 15a shows a topology of a five- or N-level inverter comprising a DC voltage source 151, a set of inverter arms 152 and an alternative output terminal 153. The internal arms comprise so-called “X” type switches constituted by IGBTs with their internal diodes. Advantageously, for the external arms, other types of switches of so-called “Y” and “Y′ type are possible. A “Y” type switch according to the invention is as illustrated in FIGS. 15a and 15b, it is constituted by an IGBT transistor with its internal diode and two parallel diodes arranged head-to-tail, the two parallel diodes being arranged in series with respect to the IGBT. A “Y” type switch according to the invention is as illustrated in FIGS. 15a and 15c, it is constituted by an IGBT transistor with its internal diode and an additional diode connected in series.

It is noted that the “Y” switch is two-way in terms of current and voltage and the “Y” switch is one-way in terms of current. With such switches, the maximum forward blocking voltage, for the “Y” (or “Y” respectively) switch of the upper arm, is obtained when the lower arm conducts. If this voltage is also distributed between the IGBT and the two diodes (or the diode respectively), this gives:

$${V}_{1} = \frac{E}{2} .$$

Thus, when it is desired to work at high voltage, on the external arms, the diodes placed in series with the IGBT transistor make it possible to divide by two the forward blocking voltage of each switch.

FIG. 16 illustrates an example of a supply offering different DC voltages necessary to an inverter according to the invention. The different DC voltages are derived from a single DC voltage power source supplying a three-phase rectifier bridge with diodes equipped with a low-pass filter with capacitor banks, then stipulating a distribution of the symmetrical voltage levels:
With, for odd N: V1, V2, . . . 0, . . . , −V2, −V1;
With, for even N: V1, V2, . . . , −V2, −V1, the potential 0 does not exist.

Where: V1=E/2

The converter according to the present invention applies advantageously to small-scale systems for converting energy where the robustness of the product and the power factor guarantee sustainable and optimum exploitation: in particular “all-electric” on-board systems and conversion of electrical energy produced by wind turbines. These systems are generally associated with confined spaces where the novel structure of the multi-level converter complies with electromagnetic compatibility and harmonic pollution standards. Such a converter allows economic, simple and compact manufacture, with optimized energy consumption.

Of course the invention is not limited to the examples which have just been described and numerous adjustments can be made to these examples without exceeding the scope of the invention.

1. Matrix converter circuit with n levels per phase comprising n conversion arms respectively supplied with n intermediate voltage levels and connected at the output thereof to a common point generating an output current, characterized in that it comprises:
two external arms supplied respectively with the highest level of positive voltage and with the lowest level of negative voltage, these two external arms each comprising a single IGBT transistor, and
two IGBT transistors connected in series by their emitter on each of the n−2 internal arms.

2. Converter circuit according to claim 1, characterized in that it comprises a control unit supplied with a measurement of the output current and configured so as to control the IGBT transistors by modulated hysteresis.

3. Converter circuit according to claim 2, characterized in that it comprises a feedback loop including a Hall effect sensor for measuring the output current.

4. Converter circuit according to claim 2, characterized in that the modulated hysteresis control unit comprises:
an adder for adding a triangular carrier with a current set point resulting from comparison between said current measurement and a current reference,
a hysteresis comparator supplied by the adder, and
a signal-processing circuit supplied by the hysteresis comparator and generating control signals for the IGBT transistors.

5. Converter circuit according to claim 1, characterized in that the control unit is configured so as to produce a chopping frequency less than five kHz.

6. Converter circuit according to claim 1, characterized in that the control unit is configured so as to produce a chopping frequency equal to two kHz.

7. Converter circuit according to claim 1, characterized by cabling constituted by flat “bus bar” type conductors comprising a plurality of metal plates for supplying the conversion arms.

8. Converter circuit according to claim 7, characterized in that each conductor is constituted by several laminated metal plates.

9. Converter circuit according to claim 1, characterized in that at least one of the two external arms also comprises a diode in series with the single IGBT transistor, the anode of the diode being connected to the emitter of the IGBT transistor.

10. Converter circuit according to claim 1, characterized in that at least one of the two external arms also comprises two diodes in parallel but in opposite directions, the assembly constituted by these diodes being placed in series with the single IGBT transistor.

11. Method for designing a matrix converter circuit with n levels per phase comprising n conversion arms supplied respectively with n intermediate voltage levels and connected at the output thereof to a common point generating an output current, this circuit comprising:
two external arms supplied respectively with the highest level of positive voltage and with the lowest level of negative voltage, these two external arms each comprising a single IGBT transistor, and
two IGBT transistors connected in series by their emitter on each of the n−2 internal arms. in which method, said converter circuit is designed by assembling several identical modular components.

12. Method according to claim 10, characterized in that the modular component comprises two parallel arms each intended to receive an intermediate-level input voltage, these arms being connected at the output at a point constituting said common point generating an output current; and in that:
each arm comprises an IGBT transistor connected in series with a mechanical switch;
on the arm to be supplied with the highest voltage level, the collector of the IGBT transistor is arranged on the side of the input capable of receiving this highest voltage level; the mechanical switch being arranged between this IGBT transistor and the common point;
on the arm to be supplied with the least high voltage level, the emitter of the IGBT transistor is arranged on the side of the input capable of receiving this least high voltage level; the mechanical switch being arranged between this IGBT transistor and this input capable of receiving this least high voltage level.

13. Method according to claim 12, characterized in that the design is achieved by lateral interlocking of the identical modular components so as to constitute the desired converter circuit; each IGBT transistor being associated with a mechanical stop intended by design to disconnect a mechanical switch.

14. Method according to claim 1, characterized in that each modular component comprises a capacitor bank arranged at the input between the two arms.

15. Converter circuit according to claim 3, characterized in that the modulated hysteresis control unit comprises:
an adder for adding a triangular carrier with a current set point resulting from comparison between said current measurement and a current reference,
a hysteresis comparator supplied by the adder, and
a signal-processing circuit supplied by the hysteresis comparator and generating control signals for the IGBT transistors.
